(19) United States
(12) Patent Application Publication
(10) Pub. No.: US 2022/0269732 A1
(43) Pub. Date: Aug. 25, 2022

(54) GENERATION OF A RECOMMENDATION FOR AUTOMATIC TRANSFORMATION OF TIMES SERIES DATA AT INGESTION

(71) Applicant: VMware, Inc., Palo Alto, CA (US)

(72) Inventors: Clement Ho Yan Pang, Sunnyvale, CA (US); Lakshmi Ganesh N.R. Kapatralla, Sunnyvale, CA (US)

(73) Assignee: VMware, Inc., Palo Alto, CA (US)

(21) Appl. No.: 17/184,263

(22) Filed: Feb. 24, 2021

(51) Int. Cl. G06F 16/9035; G06F 16/903; G06F 9/355

(52) U.S. Cl. CPC G06F 16/9035; G06F 16/90335; G06F 9/3555

(57) ABSTRACT

In a computer-implemented method for generating a recommendation for automatic transformation of times series data at ingestion, historical query data of a time series data monitoring system is analyzed, where the historical query data includes a plurality of queries and data associated with execution of the plurality of queries. Based on the analyzing, it is determined whether an execution cost of a query of the plurality of queries can be reduced by performing automatic transformation of at least a portion of times series data accessed responsive to the query at ingestion into the time series data monitoring system. In response to determining that the execution cost of the query can be reduced by performing automatic transformation at ingestion, a recommendation to perform the automatic transformation of the at least a portion of the times series data at ingestion is generated.

### BACKGROUND

Management, monitoring, and troubleshooting in dynamic environments, both cloud-based and on-premises products, is increasingly important as the popularity of such products continues to grow. As the quantities of time-sensitive data grow, conventional techniques are increasingly deficient in the management of these applications. Conventional techniques, such as relational databases, have difficulty managing large quantities of data and have limited scalability. Moreover, as monitoring analytics of these large quantities of data often have real-time requirements, the deficiencies of reliance on relational databases become more pronounced.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating a time series data monitoring system for automatic transformation of time series data at ingestion, in accordance with embodiments.

FIG. 2A is a block diagram illustrating an example ingestion node for automatic transformation of time series data at ingestion, in accordance with embodiments.

FIG. 2B is a block diagram illustrating an example aggregation node of a system for automatic transformation of time series data at ingestion, in accordance with embodiments.

FIG. 3 is a block diagram illustrating an example recommendation engine of a system for automatic transformation of time series data at ingestion, in accordance with embodiments.

FIG. 4 is a block diagram illustrating an example time series data monitoring system for automatic transformation of time series data at ingestion, in accordance with embodiments.

FIG. 5 is a block diagram of an example computer system upon which embodiments of the present invention can be implemented.

FIG. 6 depicts a flow diagram of an example process for automatic transformation of time series data at ingestion, according to an embodiment.

FIG. 7 depicts a flow diagram of an example process for aggregating data in a system for automatic transformation of time series data at ingestion, according to an embodiment.

FIG. 8 depicts a flow diagram of an example process for automatic transformation a stray data point of time series data at ingestion, according to an embodiment.

FIG. 9 depicts a flow diagram of an example process for generation of a recommendation for automatic transformation of time series data at ingestion, according to an embodiment.

FIG. 10 depicts a flow diagram of an example process for analyzing historical query data in a system for automatic transformation of time series data at ingestion, according to an embodiment.

FIG. 11 depicts a flow diagram of an example process for generating a recommendation to perform automatic transformation a stray data point of time series data at ingestion, according to an embodiment.

### DETAILED DESCRIPTION OF CERTAIN EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “analyzing,” “determining,” “generating,” “establishing,” “identifying,” “communicating,” “enabling,” “receiving,” “transforming,” “storing,” “forwarding,” “deleting,” “aggregating,” “returning,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer systems by generating recommendations for automatic transformation and/or aggregation of times series data at ingestion, rather than at query. In accordance with embodiments, a times series data monitoring system as described herein is capable of performing transformation of times series data at ingestion, rather than exclusively at query. In many circumstances, for example where a query performs data transformation or aggregation in returning a result, transformation of time series data at ingestion improves performance of the times series data monitoring system, for instance by reducing query processing response time. Embodiments described herein analyze historical query data to determine whether performance of a query could be improved by implementing data transformation and/or aggregation at ingestion.

In accordance with various embodiments, historical query data of a time series data monitoring system is analyzed, where the historical query data includes a plurality of queries and data associated with execution of the plurality of queries. Based on the analyzing, it is determined whether an execution cost of a query of the plurality of queries can be reduced by performing automatic transformation of at least a portion of times series data accessed responsive to the query at ingestion into the time series data monitoring system. In response to determining that the execution cost of the query can be reduced by performing automatic transformation at ingestion, a recommendation to perform the automatic transformation of the at least a portion of the times series data at ingestion is generated.

In some embodiments, the execution cost includes at least one of: a response time for executing the query, a processing time for executing the query, and processing cycles for executing the query. In some embodiments, analyzing the historical query data of a time series data monitoring system includes establishing at least one query response time threshold based at least in part on the historical query data, wherein a query response time greater than the at least one query response time threshold is indicated as a slow query. In some embodiments, establishing at least one query response time threshold based at least in part on the historical query data includes using pattern matching to establish the at least one query response time threshold.

In some embodiments, the data associated with execution of the plurality of queries includes query response times associated with each query of the plurality of queries. In some embodiments, the data associated with execution of the plurality of queries further includes at least one of: a number of points returned by each query of the plurality of queries, processing cycles associated with execution of each query of the plurality of queries, and processing time associated with execution of each query of the plurality of queries.

In some embodiments, generating a recommendation to perform the automatic transformation of the at least a portion of the times series data at ingestion into the time series data monitoring system includes analyzing a plurality of transformation policies on the query, wherein the plurality of transformation policies transform time series data at ingestion. At least one transformation policy of the plurality of transformation policies that reduces the execution cost of the query is identified.

In some embodiments, the recommendation including the at least one transformation policy is communicated to an administrator of the time series data monitoring system, wherein the recommendation can be selectively enabled by the administrator. In other embodiments, the recommendation including the at least one transformation policy is automatically enabled.

In some embodiments, the automatic transformation of at least a portion of times series data includes transforming data points of time series data from an input observability format to an output observability format according to configuration rules of the time series data monitoring system. In some embodiments, the automatic transformation of at least a portion of times series data includes aggregating subsets of data points of time series data into aggregated data points.

In some embodiments, the automatic transformation of data at ingestion includes receiving time series data including data points at at least one ingestion node of a time series data monitoring system, wherein the data points have an input observability format. At the at least one ingestion node, the data points the data points are transformed from the input observability format to an output observability format according to configuration rules of the time series data monitoring system. The data points having the output observability format are forwarded from the at least one ingestion node to a persistent storage device.

In some embodiments, the configuration rules of the time series data monitoring system define operations for the transforming the data points from the input observability format to the output observability format. In some embodiments, the configuration rules identify input time series data necessitating transformation to the output observability format. In some embodiments, the input observability format is one of a metric, a counter, a histogram, and a span. In some embodiments, the output observability format is one of a counter and a histogram.

In one embodiment, the data points having the input observability format are forwarded from the at least one ingestion node to the persistent storage device. In another embodiment, the data points including the input observability format are deleted subsequent transformation to the output observability format.

In some embodiments, subsets of data points having the output observability format are received from a plurality of ingestion nodes at an intermediate aggregation node between the plurality of ingestion nodes and the persistent storage device. The subsets of data points having the output observability format from the plurality of ingestion nodes are aggregated into aggregated data points having the output observability format. In some embodiments, the aggregated data points having the output observability format are forwarded from the intermediate aggregation node to the persistent storage device.

Time series data can provide powerful insights into the performance of a system. The monitoring and analysis of time series data can provide large amounts of data for analysis. Due to volume of time series data typically received, as well as the frequency of receipt of the time series data, analysis of the data can be challenging. For instance, query processing may be time and processing intensive, as there are often data transformations that are required in order to respond to the query. Embodiments described herein provide for improved handling of query requests by generating recommendations for transforming time series data from input observability atoms to output observability atoms such that a transformation is not necessary at query time. Moreover, in some embodiments, the input time series data can be discarded, allowing for improved memory management policies by only keeping the data that is needed for query processing in persistent storage.

Embodiments described herein provide users with the ability to transform time series data ingested into a time series data monitoring system at the time of ingestion to an aggregated form of the same time-series data as ingested format or transform the data and store it even as a different time-series data format, also referred to herein as an “observability atom.” For example, time series data having a histogram observability atom which can be transformed to a counter observability atom at ingestion. The time series data is then stored in persistent storage, e.g., a database, as the counter observability atom. In some embodiments, the transformation to a new observability atom at ingestion is performed in real-time. Embodiments described herein provide for generation of recommendations for transformation from one of four input observability atoms (e.g., spans, metrics, histograms, and counters) to one of two output observability atoms (e.g., counters and histograms).

As presented above, time series data monitoring systems typically process very large amounts of data, such that transformation of data to a different format or observability atom can be time-consuming and processing intensive. The efficient handling of data conversions can markedly improve performance of query processing. For instance, performing data transformation at the time of ingestion can improve query processing, by providing the data in a desired observability atom as the data is stored in the persistent storage, such that at query time no transformation of data is necessary. By analyzing historical queries of a time series data monitoring system, recommendations regarding the automatic transformation of time series data at ingestion can be generated, allowing users to enable the improved system performance.

The described embodiments speed up query processing and improve memory management, thereby improving the performance of the overall system. Hence, the embodiments of the present invention greatly extend beyond conventional methods of handling query processing of a time series data monitoring system. Moreover, embodiments of the present invention amount to significantly more than merely using a computer to perform the query processing. Instead, embodiments of the present invention specifically recite a novel process, rooted in computer technology, for generation of recommendations for automatic transformation of time series data at ingestion, to overcome a problem specifically arising in the realm of monitoring time series data and processing index updates on time series data within computer systems.

### Example System for Managing Time Series Data

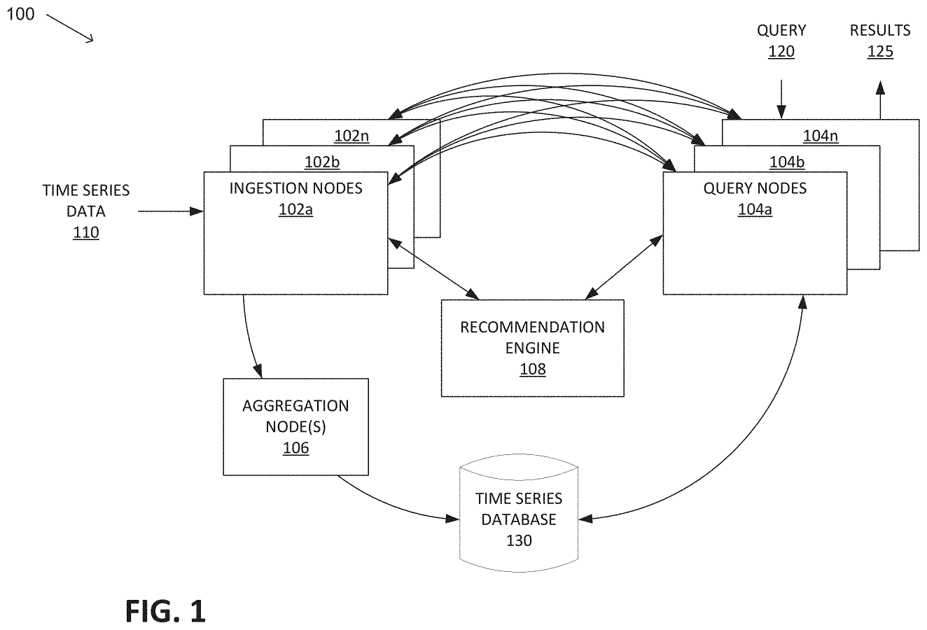

FIG. 1 is a block diagram illustrating an embodiment of a system 100 for automatic transformation of time series data at ingestion, according to embodiments. System 100 is a distributed system including multiple ingestion nodes 102a through 102n (collectively referred to herein as ingestion nodes 102), multiple query nodes 104a through 104n (collectively referred to herein as query nodes 104), and recommendation engine 108. Time series 110 is received at ingestion nodes 102 and stored within time series database 130. Query nodes 104 receive at least one query 120 for querying against time series database 130. Results 125 of query 120 are returned upon execution of query 120. Recommendation engine 108 is configured to analyze historical query data and determine whether query performance would be improved by automatically transforming time series data at ingestion.

It should be appreciated that system 100 can include any number of ingestion nodes 102 and multiple query nodes 104. Ingestion nodes 102 and query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Time series data 110 is received at at least one ingestion node 102a through 102n. In some embodiments, time series data includes a numerical measurement of a system or activity that can be collected and stored as a metric (also referred to as a “stream”). For example, one type of metric is a CPU load measured over time. Other examples include, service uptime, memory usage, etc. It should be appreciated that metrics can be collected for any type of measurable performance of a system or activity. Operations can be performed on data points in a stream. In some instances, the operations can be performed in real time as data points are received. In other instances, the operations can be performed on historical data. Metrics analysis include a variety of use cases including online services (e.g., access to applications), software development, energy, Internet of Things (IoT), financial services (e.g., payment processing), healthcare, manufacturing, retail, operations management, and the like. It should be appreciated that the preceding examples are non-limiting, and that metrics analysis can be utilized in many different types of use cases and applications.

In accordance with some embodiments, a data point in a stream (e.g., in a metric) includes a name, a source, a value, and a time stamp. Optionally, a data point can include one or more tags (e.g., point tags). For example, a data point for a metric may include:
A name—the name of the metric (e.g., CPU_idle, service.uptime)
A source—the name of an application, host, container, instance, or other entity generating the metric (e.g., web_server_1, app1, app2)
A value—the value of the metric (e.g., 99% idle, 1000, 2000)
A timestamp—the timestamp of the metric (e.g., 1418436586000)
One or more point tags (optional)—custom metadata associated with the metric (e.g., location=las_vegas, environment=prod)

Ingestion nodes 102 are configured to process received data points of time series data 110 for persistence and indexing. In some embodiments, ingestion nodes 102 forward the data points of time series data 110 to time series database 130 for storage. In some embodiments, the data points of time series data 110 are transmitted to an intermediate buffer for handling the storage of the data points at time series database 130. In one embodiment, time series database 130 can store and output time series data, e.g., TS1, TS2, TS3, etc. The data can include times series data, which may be discrete or continuous. For example, the data can include live data fed to a discrete stream, e.g., for a standing query. Continuous sources can include analog output representing a value as a function of time. With respect to processing operations, continuous data may be time sensitive, e.g., reacting to a declared time at which a unit of stream processing is attempted, or a constant, e.g., a 10V signal. Discrete streams can be provided to the processing operations in timestamp order. It should be appreciated that the time series data may be queried in real-time (e.g., by accessing the live data stream) or offline processing (e.g., by accessing the stored time series data).

In accordance with various embodiments, received data points of time series data 110 also have an associated input observability format, also referred to herein as “observability atoms.” In some embodiments, the configuration rules of the time series data monitoring system define operations for the transforming the data points from the input observability atom to the output observability atom. In some embodiments, the configuration rules identify input time series data necessitating transformation to the output observability atom. In some embodiments, the input observability atom is one of a metric, a counter, a histogram, and a span. In some embodiments, wherein the output observability atom is one of a counter and a histogram.

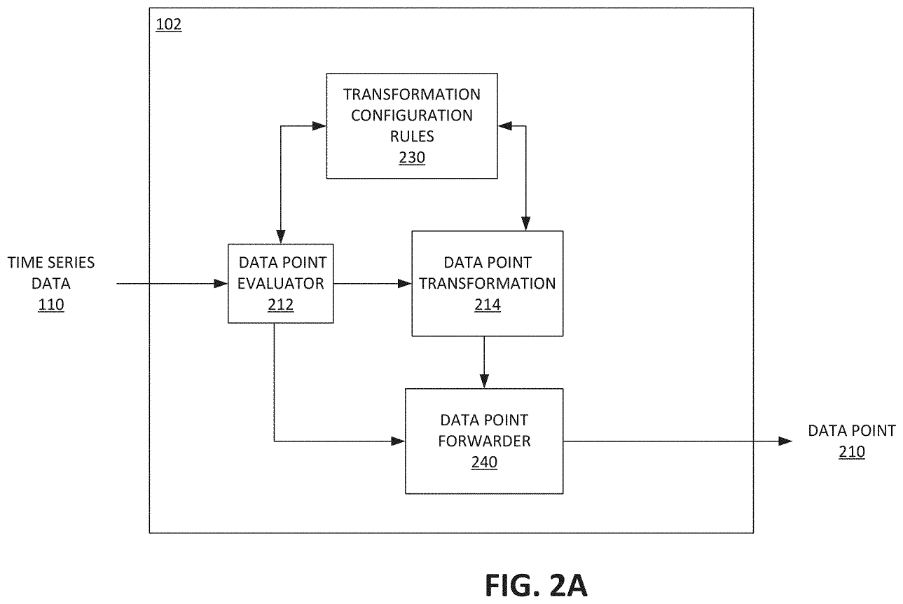

FIG. 2A is a block diagram illustrating an example ingestion node 102 (e.g., one of ingestion nodes 102a through 102n of FIG. 1) for automatic transformation of time series data 110 at ingestion, in accordance with embodiments. In one embodiment, ingestion node 102 receives time series data 110 (e.g., as data points), evaluates whether data points of time series data 110 requires transformation from an input observability atom to an output observability atom, and performs the transformation when necessary. Ingestion node 102 includes data point evaluator 212, data point transformation 214, transformation configuration rules 230, and data point forwarder 240. It should be appreciated that ingestion node 102 is one node of a plurality of ingestion nodes of a distributed system for managing time series data (e.g., system 100).

In the example shown in FIG. 2A, time series data 110 including data points is received. In one embodiment, time series data 110 including data points is received from an application or system. Time series data 110 is received at data point evaluator 212. Data point evaluator 212 is configured to evaluate each data point according to transformation configuration rules 230 and determine whether a transformation of the data point from an input observability atom to an output observability atom is to be performed according to transformation configuration rules 230. For example, configuration rules 230 may indicate that time series data 110 having a particular point tag or name is to be transformed from the input observability atom to a particular output observability atom.

In one embodiment, transformation configuration rules 230 include an indication of the input observability atom to be transformed. In accordance various embodiments, the input observability format is one of a metric, a counter, a histogram, and a span. Transformation configuration rules 230 also include an expression to select the ingested data points of time series 110 to be transformed, e.g., limit(100, traces(spans(“xyz.*))). Data point evaluator 212 scans the data points of time series 110 to identify data points that satisfy the expression, and then forwards the data points to data point transformation 214 to execute a transformation from the input observability atom to an output observability atom.

Responsive to determining that a data point does not require transformation to a different observability atom according to transformation configuration rules 230, data point evaluator 212 forwards the data point 210 to data point forwarder 240 for ultimate forwarding to persistent storage. Data point forwarder 240 is configured to forward the data point 210 to persistent storage (e.g., time series database 130 of FIG. 1).

Responsive to determining that a data point does require transformation to a different observability atom according to transformation configuration rules 230, data point evaluator 212 forwards the data point to data point transformation 214. Data point transformation 214 is configured to transform data points from an input observability atom to an output observability atom, according to transformation configuration rules 230.

Data point transformation 214 receives the data points to be transformed, where each data point has a name, a source identifier, and one or more point tags (e.g., a set of point tags). Transformation configuration rules 230 allow for the configuration of a common set of transformation to the input data points having an input observability atom. In some embodiments, transformation configuration rules 230 have a priority order. Upon configuring the transformation configuration rules 230 for a transformation, the priority order can be set depending on which input observability atom will be transformed. Examples of the common set of transformation configuration rules 230 include, without limitation:
Rename the data point;
Rename a dimension of the data point (e.g., source, point tag);
Add a point tag;
Remove all point tags except listed point tags;
Drop the data point if the point tag is missing; and
Drop the data point if metric name matches

In accordance various embodiments, the output observability format is one of a counter and a histogram. The following are example operations describing the transformation from one of a metric, a counter, a histogram, and a span observability atom to one of a counter and a histogram observability atom.

In one embodiment, the transformation is from a metric observability atom to a counter observability atom. In one example transformation, the value of the counter can be set through four options. In the first option, the value of the metric is added as the delta of the counter. In the second option, a constant value is added regardless of what the value of the underlying metric is (e.g., the value of the metric is ignored but this value is added to or subtracted from the counter). In the third option, the value of a point tag is used as the counter increment. In the fourth option, numerical transformation is performed (e.g., using the metric and transforming a value of the metric, such as dividing the value by a fixed value, and used the transformed value as the value used by the counter).

In one embodiment, the transformation is from a span observability atom to a counter observability atom. In one example transformation, the duration of the span is set as the value of the counter. The counter value in this case can be a constant value, where the value part of the key-value pair of the span is the value used in the counter.

In one embodiment, the transformation is from a histogram observability atom to a counter observability atom. In one example transformation, a median of the histogram is determined and put it into the counter, where the median can be one of:
P99 percentile aggregation of the histogram;
Number of Centroids;
Sum of all the counts; and
Number of Observations in a histogram.

In one embodiment, the transformation is from a counter observability atom to a counter observability atom. In one example transformation, the value of the counter as set as one of three options: static value, a value of the data point (e.g., direct transfer), or a value from the point tag.

In some embodiments, the transformation is to a histogram observability atom, where a histogram uses a numerical value and can be a sampled value (e.g., latency, count, etc.) In one embodiment, the transformation is from a metric observability atom to a histogram observability atom. In one example transformation, the transformation includes using one of a static value, using a value of the data point (e.g., a direct transfer), or a value from a point tag.

In one embodiment, the transformation is from a metric observability atom to a histogram observability atom. In one example transformation, the transformation includes using one of a value of a span or a value from a key-value pair of the span.

In one embodiment, the transformation is from a metric observability atom to a histogram observability atom. In one example transformation, the transformation includes using one of a value of the metric or a value of the key-value pair of the metric.

In one embodiment, the transformation is from a metric observability atom to a histogram observability atom. In one example transformation, the transformation includes using one of three options: static value, a value of the data point (e.g., direct transfer), or a value from the point tag.

Upon completing a transformation to an output observability atom, data point transformation 214 forwards the data point 210 to data point forwarder 240 for ultimate forwarding to persistent storage. It should be appreciated that in accordance with some embodiments, data point forwarder 240 forwards data points 210 to an intermediate node (e.g., an aggregation node) en route to persistent storage. In some embodiments, as described above, there are multiple ingestion nodes 102, where each ingestion node only receives a subset of a time series data 110 received at the time series data monitoring system. Data points 210, both those that are transformed and those that are note transformed, can be forwarded to an aggregation node for aggregating subsets (e.g., snippets) of data points.

FIG. 2B is a block diagram illustrating an example aggregation node 106 of a system for automatic transformation of time series data at ingestion, in accordance with embodiments. Aggregation node 106 includes data collector 270 for receiving and aggregating data points 210 into aggregated data 290. The aggregated data 290 is then forwarded by aggregated data forwarder 280 to the next node in the system, e.g., a persistent storage node. In some embodiments, there are multiple layers of aggregation nodes 106, such that a plurality of aggregation nodes 106 receive data points 210 of time series data from multiple ingestion nodes, and then forward the aggregated data 290 to another higher-level aggregation node 106, which then aggregates the received aggregated data 290 and forwards aggregated data 290 to the persistent storage node. It should be appreciated that there can be any number of layers of aggregation nodes.

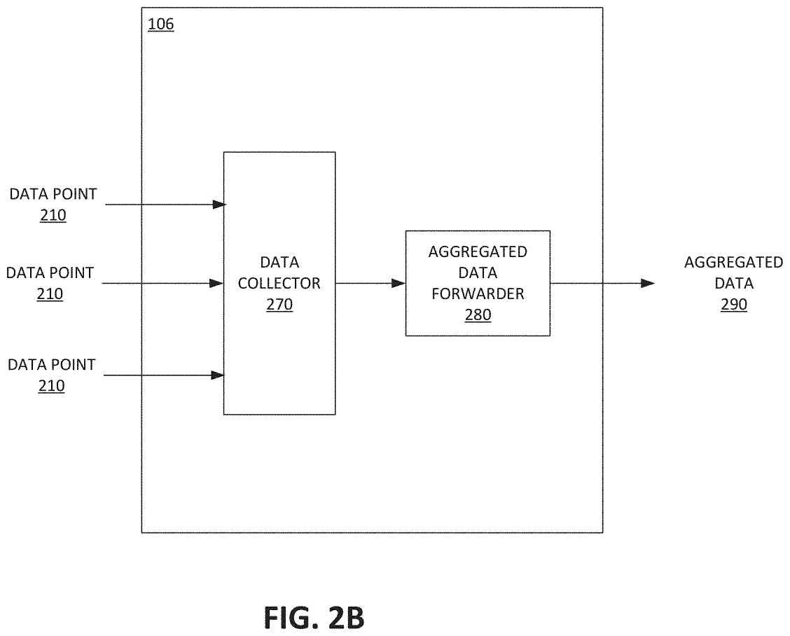

FIG. 3 is a block diagram illustrating an example recommendation engine 108 of a system for automatic transformation of time series data at ingestion, in accordance with embodiments. In one embodiment, recommendation engine 108 receives historical query data 310 and transformation policies 330 and generates a recommendation 350 to perform the automatic transformation of the at least a portion of the times series data at ingestion (e.g., at ingestion node 102). Recommendation engine 108 is configured to analyze historical query data 310 and determine whether performance of a query could be improved (e.g., whether an execution cost of a query can be reduced) by implementing data transformation and/or aggregation at ingestion rather than at query.

For instance, recommendation engine 108 is configured to detect whether queries are processing slow and suggest transformation and/or aggregation policies that could be applied on ingestion such that the queries themselves perform faster rather than at performing the transformation and/or aggregation policies at query. For example, if a user wants to execute a query that performs a summation on a large set of time series and returns multiple dimensions, the query performance can be improved if the time series are transformed and retained as counters upon ingestion rather than performing the transformation at query.

Historical query data 310 is received at historical query data analyzer 320. In some embodiments, historical query data 310 includes a plurality of queries and data associated with execution of the plurality of queries. In some embodiments, the data associated with execution of the plurality of queries includes query response times associated with each query of the plurality of queries. In some embodiments, the data associated with execution of the plurality of queries further includes at least one of: a number of points returned by each query of the plurality of queries, processing cycles associated with execution of each query of the plurality of queries, and processing time associated with execution of each query of the plurality of queries.

Historical query data analyzer 320 analyzes historical query data 310 and determines an execution cost of the queries. In some embodiments, the execution cost includes at least one of: a response time for executing the query, a processing time for executing the query, and processing cycles for executing the query.

In some embodiments, historical query data analyzer 320 includes threshold established 322 for identifying and establishing thresholds based on historical query data 310. Thresholds are used for comparing performance of queries and classifying queries according to their performance. For example, a query having a response time greater than a threshold is classified as a slow query. In some embodiments, threshold establisher 322 includes pattern matcher 324 for performing pattern matching on queries of historical data 310 for classifying queries according to response time. Pattern matching is used to compare queries, such that the query performance can be compared.

Historical query data analyzer 320 generates thresholds 332 and forwards thresholds 332, as well as queries 334 of historical query data 310, to recommendation determiner 340. Recommendation determiner 340 also receives transformation policies 330 from system 100, where transformation policies 330 includes the operations for performing transformation and aggregation of the time series data at ingestion, e.g., procedures for transforming the data points from the input observability atom to the output observability atom or for performing aggregation of data points. Recommendation determiner 340 analyzes outcomes by applying transformation policies 330 to queries 334 and evaluating the outcomes against thresholds 332.

Recommendation determiner 340 generates at least one recommendation 350 that includes a transformation and/or aggregation policy at ingestion for a query that will improve performance of the query. In some embodiments, recommendation 350 includes information on how the performance of the associated query is improved by implementing the transformation and/or aggregation policy of recommendation 350 at ingestion rather than at query. In some embodiments, recommendation 350 also includes a new query. For example, by performing that transformation of data at ingestion rather than at query, the original query no longer needs to perform the transformation, and the new query removes the transformation that is no longer needed.

In some embodiments, recommendation 350 including at least one transformation policy 330 is communicated to an administrator of the time series data monitoring system 100, wherein recommendation 350 can be selectively enabled by the administrator. In other embodiments, recommendation 350 including at least one transformation policy 330 is automatically enabled by system 100.

For example, a user is attempting to perform a summation of a multiple time series and the summation operation is slow. In response to recommendation engine 108 making a determination that the summation operation is slow, recommendation 350 is generated that suggests a transformation policy 330 that makes the summation operation perform faster by implementing the transformation policy 330 at ingestion. Recommendation 350 may also include information as to the performance improvement, such as stating that a query can be improved by a particular percentage by implementing the transformation policy 330.

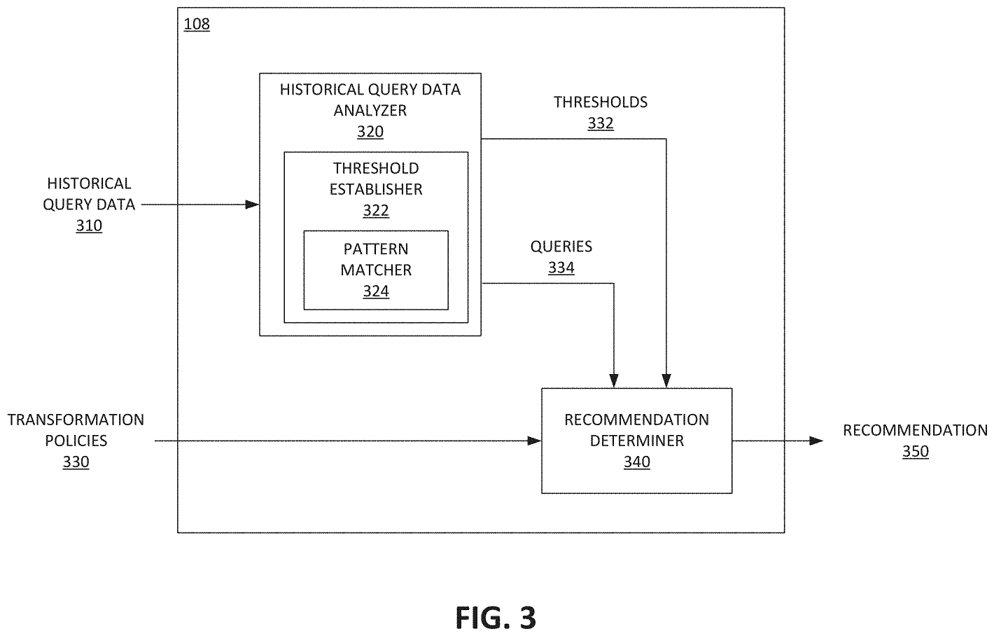

FIG. 4 is a block diagram illustrating an example time series data monitoring system 400 for automatic transformation of time series data 410 at ingestion, in accordance with embodiments. System 400 is a distributed system including multiple ingestion nodes having data transformation and aggregation policy (DTAP) engines 401 (e.g. ingestion nodes 102a through 102n of FIG. 1), an aggregation node 404, a recommendation engine 405, a distributed database 406, and a query service engine 408. Time series 410 is received at ingestion nodes, in some embodiments via application servers 412. Query service engine 408 may be implemented within and distributed over one or more query nodes (e.g., query nodes 104a through 104n of FIG. 1).

It should be appreciated that system 400 can include any number of ingestion nodes and query nodes. Ingestion nodes and query nodes can be distributed over a network of computing devices in many different configurations. For example, the respective ingestion nodes and query nodes can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Time series data 410 is received at at least one ingestion node. In accordance with various embodiments, received data points of time series data 410 also have an associated input observability format, also referred to herein as “observability atoms.” In some embodiments, a load balancer distributes time series 410 over the ingestion node, for purposes of handling the volume of time series 410 in real-time. Each data point of time series 410 is received and processed at an ingestion node for purposes of determining whether the data point should be transformed into a different observability atom (e.g., as described in FIGS. 1, 2A, and 2B) according to a transformation policy and for performing aggregation on the data points at aggregation node 404 in accordance with an aggregation policy. DTAP engine 401 receives the data points having an input observability atom and performs transformation and/or aggregation in accordance with particular transformation and/or aggregation policies as directed.

In some embodiments, the aggregation policy as defined by an aggregation policy of DTAP engine 401 are configuration rules that define operations for the transforming the data points from the input observability format to the output observability format (e.g., as described above at FIG. 2A). In some embodiments, the configuration rules identify input time series data necessitating transformation to the output observability format. In some embodiments, the input observability format is one of a metric, a counter, a histogram, and a span. In some embodiments, the output observability format is one of a counter and a histogram.

Aggregated data is output from ingestion node as a subset (e.g., snippet) of the total aggregated data for system 400 and received at aggregation node 404. In one embodiment, aggregation node 404 includes a collector service 428 for aggregating all the transformed data points and a groundskeeper service for cleaning up and finalizing the aggregated data for forwarding to distributed database 406 (e.g., persistent storage). It should be appreciated that there can be one or more intermediate aggregation nodes 404 for scalability.

Recommendation engine 405 is configured to generate a recommendation for automatic transformation of time series data at ingestion, in accordance with embodiments. Recommendation engine 405 receives historical query data 413 and transformation policies 415 and generates a recommendation 420 to perform the automatic transformation of the at least a portion of the times series data at ingestion (e.g., at DTAP 401 of an ingestion node). Recommendation engine 405 is configured to analyze historical query data 413 and determine whether performance of a query could be improved (e.g., whether an execution cost of a query can be reduced) by implementing data transformation and/or aggregation at ingestion rather than at query.

Historical query data 413 is received at historical recommendation engine 405. In some embodiments, historical query data 413 includes a plurality of queries and data associated with execution of the plurality of queries. In some embodiments, the data associated with execution of the plurality of queries includes query response times associated with each query of the plurality of queries, a number of points returned by each query of the plurality of queries, processing cycles associated with execution of each query of the plurality of queries, and processing time associated with execution of each query of the plurality of queries.

Analysis layer 407 of recommendation engine 405 analyzes historical query data 413 and uses pattern matching to establish threshold for user queries. Thresholds are used for comparing performance of queries and classifying queries according to their performance. For example, a query having a response time greater than a threshold is classified as a slow query. Pattern matching is used to compare queries, such that the query performance can be compared.

Analysis layer 407 generates thresholds and forwards the thresholds and user queries of historical query data 413, to recommendation layer 409. Recommendation layer 409 also receives DTAP policies 415 from DTAP engine 401, where DTAP policies 415 include the operations for performing transformation and aggregation of the time series data at ingestion, e.g., procedures for transforming the data points from the input observability atom to the output observability atom or for performing aggregation of data points. Recommendation layer 409 analyzes outcomes by applying DTAP policies 415 to the user queries and evaluating the outcomes against the thresholds.

In some embodiments, the DTAP policies 415 are evaluated one at a time as received from the DTAP engine 401. In such embodiments, a determination is made as to whether a suitable DTAP policy 415 has been found. If not, a new DTAP policy 415 is request from DTAP engine 401. If a suitable DTAP policy has been found, the DTAP policy 415 is forwarded to query service engine 408.

Recommendation layer 409 generates at least one recommendation 420 that includes a transformation and/or aggregation policy at ingestion for a query that will improve performance of the query. In some embodiments, recommendation 420 includes information on how the performance of the associated query is improved by implementing the transformation and/or aggregation policy of recommendation 420 at ingestion rather than at query (e.g., a cost). In some embodiments, recommendation 420 also includes a new query. For example, by performing that transformation of data at ingestion rather than at query, the original query no longer needs to perform the transformation, and the new query removes the transformation that is no longer needed.

In some embodiments, recommendation 420 including at least one DTAP policy 415 is communicated to an administrator of the time series data monitoring system 400, wherein recommendation 420 can be selectively enabled by the administrator. In other embodiments, recommendation 420 including at least one DTAP policy 415 is automatically enabled by system 400.

Hence, the embodiments of the present invention greatly extend beyond conventional methods of handling query processing a time series data monitoring system. The described embodiments speed up query processing and improve memory management, thereby improving the performance of the overall system. Hence, the embodiments of the present invention greatly extend beyond conventional methods of query handling of a time series data monitoring system by recommending that some time series data is transformed at ingestion rather than at query. Moreover, embodiments of the present invention amount to significantly more than merely using a computer to perform the automatic transformation of times series data at ingestion and for generating recommendations to automatically transform times series data at ingestion. Instead, embodiments of the present invention specifically recite a novel process, rooted in computer technology, for automatic transformation of time series data at ingestion, to overcome a problem specifically arising in the realm of monitoring time series data and query processing on time series data within computer systems.

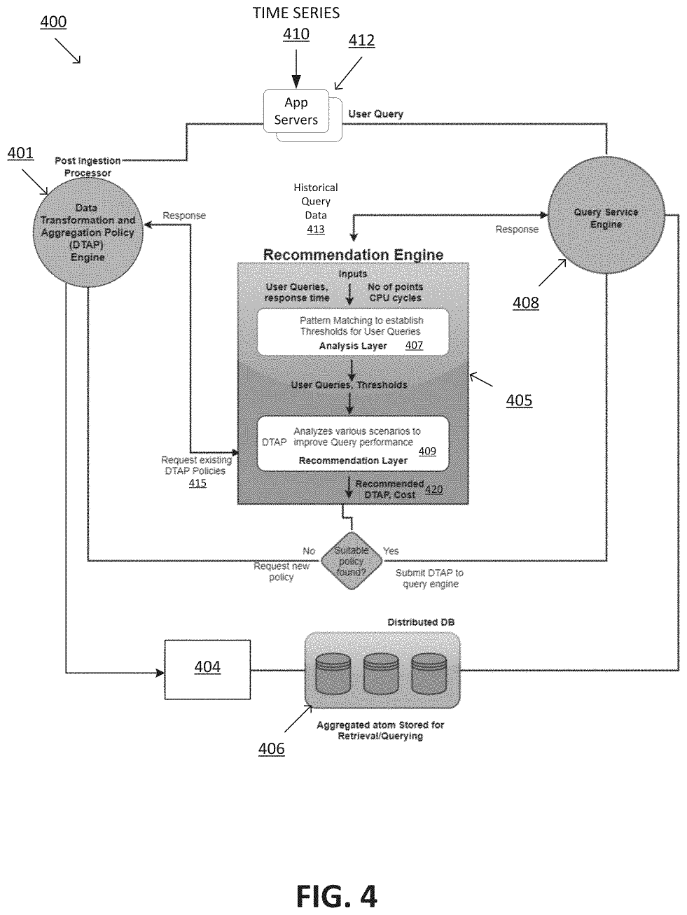

FIG. 5 is a block diagram of an example computer system 500 upon which embodiments of the present invention can be implemented. FIG. 5 illustrates one example of a type of computer system 500 (e.g., a computer system) that can be used in accordance with or to implement various embodiments which are discussed herein.

It is appreciated that computer system 500 of FIG. 5 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 500 of FIG. 5 is well adapted to having peripheral tangible computer-readable storage media 502 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 500 of FIG. 5 includes an address/data bus 504 for communicating information, and a processor 506A coupled with bus 504 for processing information and instructions. As depicted in FIG. 5, computer system 500 is also well suited to a multi-processor environment in which a plurality of processors 506A, 506B, and 506C are present. Conversely, computer system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled with bus 504 for storing information and instructions for processors 506A, 506B, and 506C. Computer system 500 also includes computer usable non-volatile memory 510, e.g., read only memory (ROM), coupled with bus 504 for storing static information and instructions for processors 506A, 506B, and 506C. Also present in computer system 500 is a data storage unit 512 (e.g., a magnetic or optical disc and disc drive) coupled with bus 504 for storing information and instructions. Computer system 500 also includes an alphanumeric input device 514 including alphanumeric and function keys coupled with bus 504 for communicating information and command selections to processor 506A or processors 506A, 506B, and 506C. Computer system 500 also includes an cursor control device 516 coupled with bus 504 for communicating user input information and command selections to processor 506A or processors 506A, 506B, and 506C. In one embodiment, computer system 500 also includes a display device 518 coupled with bus 504 for displaying information.

Referring still to FIG. 5, display device 518 of FIG. 5 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, touch screen, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. Computer system 500 is also well suited to having a cursor directed by other means such as, for example, voice commands. In various embodiments, alphanumeric input device 514, cursor control device 516, and display device 518, or any combination thereof (e.g., user interface selection devices), may collectively operate to provide a graphical user interface (GUI) 530 under the direction of a processor (e.g., processor 506A or processors 506A, 506B, and 506C). GUI 530 allows user to interact with computer system 500 through graphical representations presented on display device 518 by interacting with alphanumeric input device 514 and/or cursor control device 516.

Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet. In one embodiment, I/O device 520 includes a transmitter. Computer system 500 may communicate with a network by transmitting data via I/O device 520.

Referring still to FIG. 5, various other components are depicted for computer system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

### Example Methods of Operation

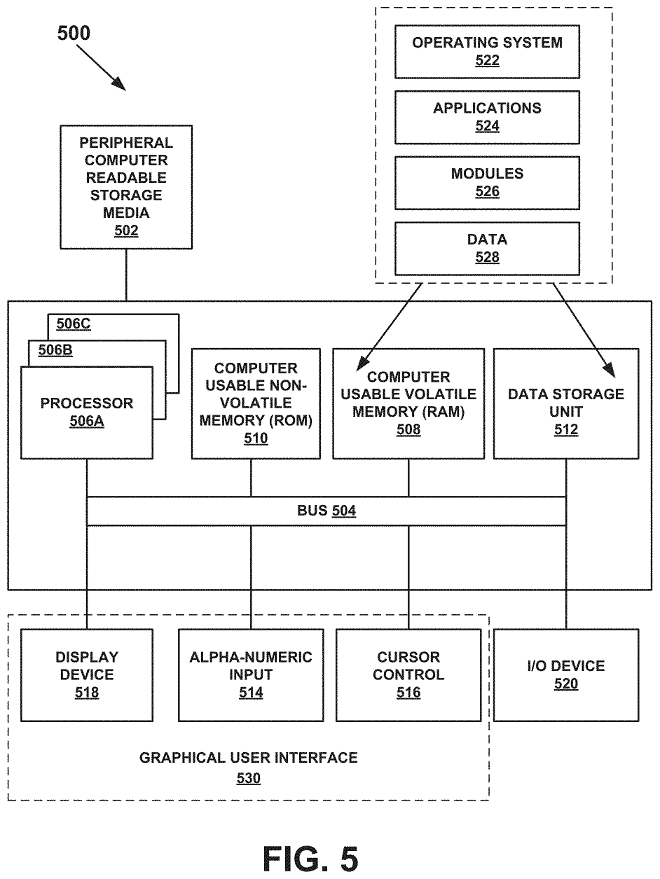

The following discussion sets forth in detail the operation of some example methods of operation of embodiments. With reference to FIGS. 6 through 8, flow diagrams 600, 700, 800, 900, 1000, and 1100 illustrate example procedures used by various embodiments. The flow diagrams 600, 700, 800, 900, 1000, and 1100 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 500). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagrams 600, 700, 800, 900, 1000, and 1100 may be performed in an order different than presented and/or not all of the procedures described in flow diagrams 600, 700, 800, 900, 1000, and 1100 may be performed. It is further appreciated that procedures described in flow diagrams 600, 700, 800, 900, 1000, and 1100 may be implemented in hardware, or a combination of hardware with firmware and/or software provided by computer system 500.

FIG. 6 depicts a flow diagram 600 of an example process for automatic transformation of time series data at ingestion, according to an embodiment. At procedure 610 of flow diagram 600, time series data including data points is received at at least one ingestion node of a time series data monitoring system, wherein the data points have an input observability format. At procedure 620, at the at least one ingestion node, the data points the data points are transformed from the input observability format to an output observability format according to configuration rules of the time series data monitoring system. In some embodiments, the configuration rules of the time series data monitoring system define operations for the transforming the data points from the input observability format to the output observability format. In some embodiments, the configuration rules identify input time series data necessitating transformation to the output observability format. In some embodiments, the input observability format is one of a metric, a counter, a histogram, and a span. In some embodiments, the output observability format is one of a counter and a histogram. At procedure 630, the data points having the output observability format are forwarded from the at least one ingestion node to a persistent storage device.

In some embodiments, as shown at procedure 640, it is determined whether to maintain the original data points having the input observability format. Provided it is determined to maintain the original data points having the input observability format, as shown at procedure 650, the data points having the input observability format are forwarded from the at least one ingestion node to the persistent storage device. Provided it is determined not to maintain the original data points having the input observability format, as shown at procedure 660, the data points including the input observability format are deleted subsequent transformation to the output observability format.

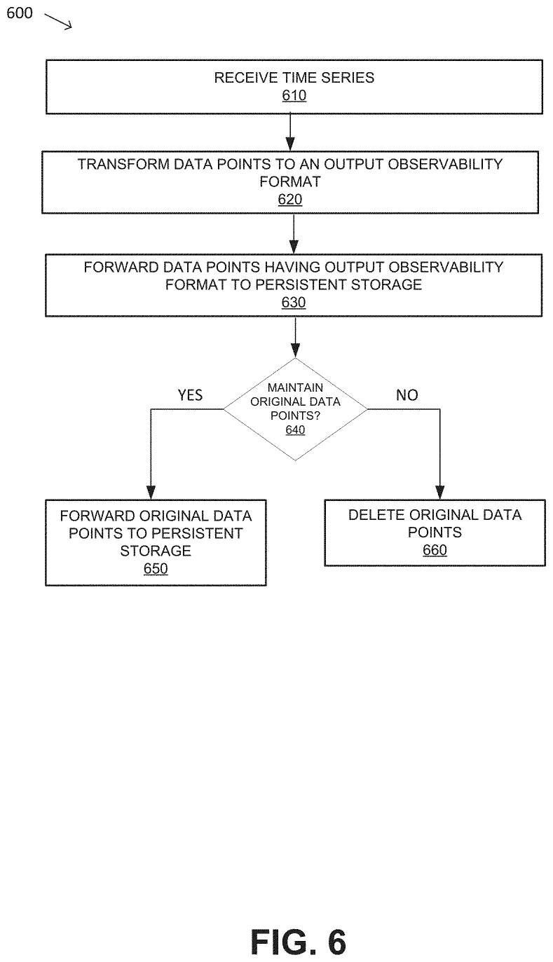

In some embodiments, there are one or more intermediate aggregation nodes between the ingestion nodes and the persistent storage. FIG. 7 depicts a flow diagram 700 of an example process for aggregating data in a system for automatic transformation of time series data at ingestion, according to an embodiment. At procedure 710 of flow diagram 700, subsets of data points having the output observability format are received from a plurality of ingestion nodes at an intermediate aggregation node between the plurality of ingestion nodes and the persistent storage device. At procedure 720, the subsets of data points having the output observability format from the plurality of ingestion nodes are aggregated into aggregated data points having the output observability format. In some embodiments, as show at procedure 730, the aggregated data points having the output observability format are forwarded from the intermediate aggregation node to the persistent storage device.

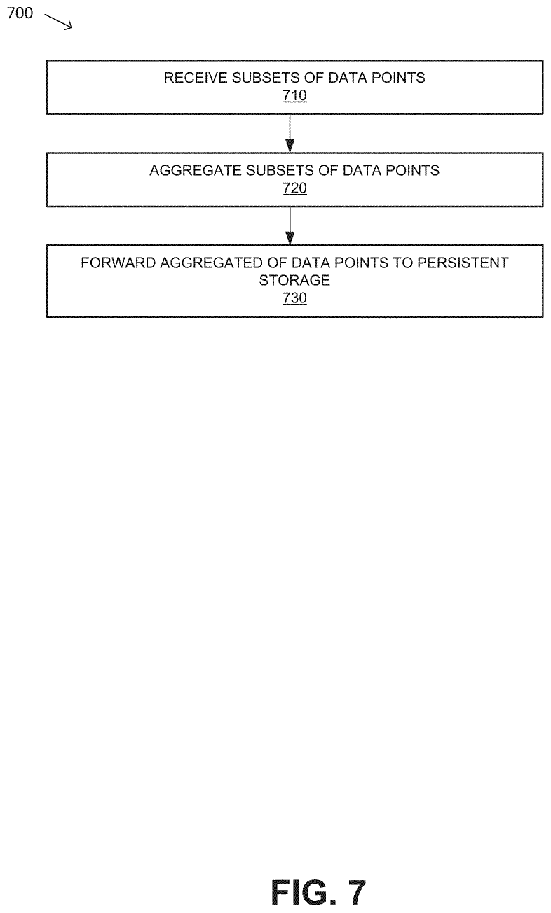

FIG. 8 depicts a flow diagram 800 of an example process for automatic transformation a stray data point of time series data at ingestion, according to an embodiment. At procedure 810 of flow diagram 800, a stray data point of the time series data having the input observability format is received at the at least one ingestion node, the stray data point received subsequent the forwarding of the data points having the output observability format to the persistent storage device. At procedure 820, the stray data point is transformed at the at least one ingestion node from the input observability format to the output observability format according to the configuration rules of the time series data monitoring system. At procedure 830, the stray data point having the output observability format is forwarded from the at least one ingestion node to the persistent storage device. In some embodiments, as shown at procedure 840, responsive to receiving a query request associated with the data points having the output observability format and the stray data point having the output observability format, the data points having the output observability format and the stray data point having the output observability format are aggregated into a complete set of aggregated data points having the output observability format. At procedure 850, a result to the query request is returned using the complete set of aggregated data points.

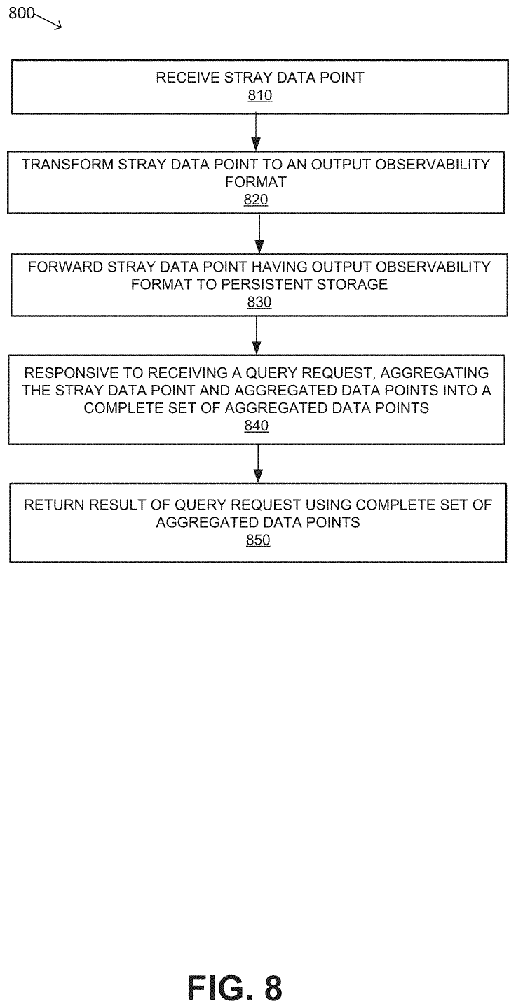

FIG. 9 depicts a flow diagram 900 of an example process for generation of a recommendation for automatic transformation of time series data at ingestion, according to an embodiment. At procedure 910 of flow diagram 900, historical query data of a time series data monitoring system is analyzed, where the historical query data includes a plurality of queries and data associated with execution of the plurality of queries. In some embodiments, the data associated with execution of the plurality of queries includes query response times associated with each query of the plurality of queries. In some embodiments, the data associated with execution of the plurality of queries further includes at least one of: a number of points returned by each query of the plurality of queries, processing cycles associated with execution of each query of the plurality of queries, and processing time associated with execution of each query of the plurality of queries. In some embodiments, the automatic transformation of at least a portion of times series data includes transforming data points of time series data from an input observability format to an output observability format according to configuration rules of the time series data monitoring system. In some embodiments, the automatic transformation of at least a portion of times series data includes aggregating subsets of data points of time series data into aggregated data points.

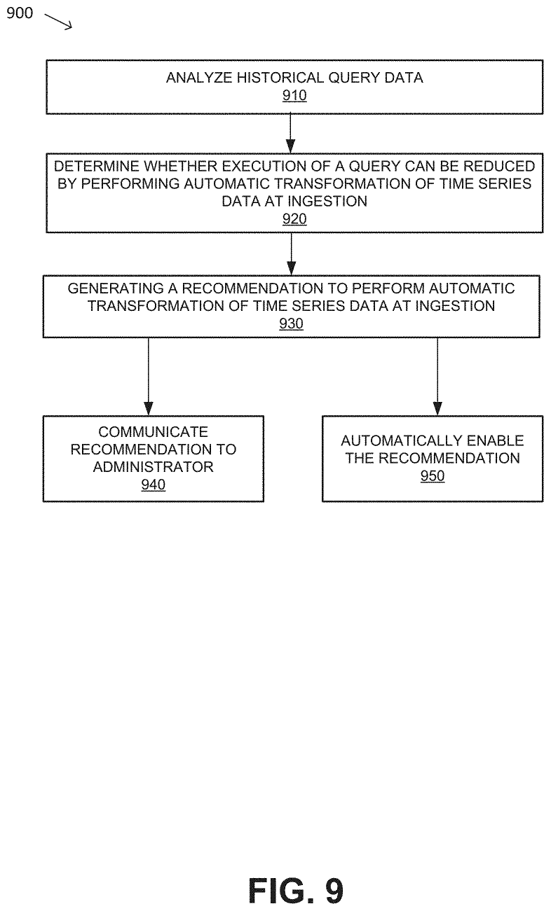

At procedure 920, based on the analyzing, it is determined whether an execution cost of a query of the plurality of queries can be reduced by performing automatic transformation of at least a portion of times series data accessed responsive to the query at ingestion into the time series data monitoring system. In some embodiments, the execution cost includes at least one of: a response time for executing the query, a processing time for executing the query, and processing cycles for executing the query. In some embodiments, procedure 920 is performed according to flow diagram 1000 of FIG. 10.

FIG. 10 depicts a flow diagram 1000 of an example process for analyzing historical query data in a system for automatic transformation of time series data at ingestion, according to an embodiment. At procedure 1010 of flow diagram 1000, at least one query response time threshold is established based at least in part on the historical query data, wherein a query response time greater than the at least one query response time threshold is indicated as a slow query. At procedure 1020, at least one query response time threshold is established based at least in part on the historical query data includes using pattern matching to establish the at least one query response time threshold.

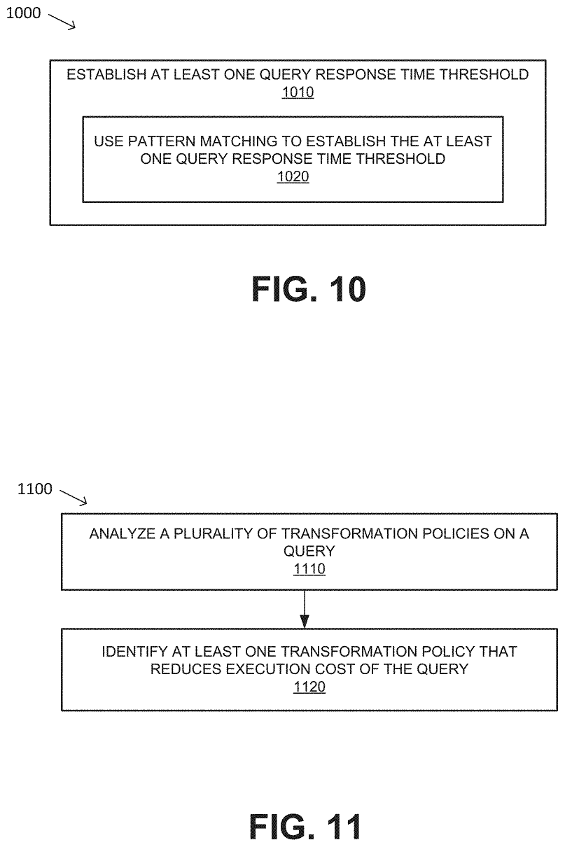

With reference to FIG. 9, at procedure 930, in response to determining that the execution cost of the query can be reduced by performing automatic transformation at ingestion, a recommendation to perform the automatic transformation of the at least a portion of the times series data at ingestion is generated. In some embodiments, procedure 930 is performed according to flow diagram 1100 of FIG. 11.

FIG. 11 depicts a flow diagram of an example process for generating a recommendation to perform automatic transformation a stray data point of time series data at ingestion, according to an embodiment. At procedure 1110 of flow diagram 1100, a plurality of transformation policies on the query are analyzed, wherein the plurality of transformation policies transform time series data at ingestion. At procedure 1120, at least one transformation policy of the plurality of transformation policies that reduces the execution cost of the query is identified.

With reference to FIG. 9, in accordance with some embodiments, as shown at procedure 940, the recommendation including the at least one transformation policy is communicated to an administrator of the time series data monitoring system, wherein the recommendation can be selectively enabled by the administrator. In other embodiments, as shown at procedure 950, the recommendation including the at least one transformation policy is automatically enabled.

It is noted that any of the procedures, stated above, regarding the flow diagrams of FIGS. 6 through 11 may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system--computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)--CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer-implemented method for generating a recommendation for automatic transformation of times series data at ingestion, the method comprising:
analyzing historical query data of a time series data monitoring system, wherein the historical query data comprises a plurality of queries and data associated with execution of the plurality of queries;
determining, based on the analyzing, whether an execution cost of a query of the plurality of queries can be reduced by performing automatic transformation of at least a portion of times series data accessed responsive to the query at ingestion of the at least a portion of the times series data into the time series data monitoring system; and
in response to determining that the execution cost of the query can be reduced by performing automatic transformation of the at least a portion of the times series data accessed responsive to the query at ingestion of the at least a portion of the times series data into the time series data monitoring system, generating a recommendation to perform the automatic transformation of the at least a portion of the times series data at ingestion into the time series data monitoring system.

2. The method of claim 1, wherein the execution cost comprises at least one of: a response time for executing the query, a processing time for executing the query, and processing cycles for executing the query.

3. The method of claim 1, wherein the analyzing the historical query data of a time series data monitoring system comprises:
establishing at least one query response time threshold based at least in part on the historical query data, wherein a query response time greater than the at least one query response time threshold is indicated as a slow query.

4. The method of claim 3, wherein the establishing at least one query response time threshold based at least in part on the historical query data comprises:
using pattern matching to establish the at least one query response time threshold.

5. The method of claim 1, wherein the data associated with execution of the plurality of queries comprises query response times associated with each query of the plurality of queries.

6. The method of claim 5, wherein the data associated with execution of the plurality of queries further comprises at least one of: a number of points returned by each query of the plurality of queries, processing cycles associated with execution of each query of the plurality of queries, and processing time associated with execution of each query of the plurality of queries.

7. The method of claim 1, wherein the generating a recommendation to perform the automatic transformation of the at least a portion of the times series data at ingestion into the time series data monitoring system comprises:
analyzing a plurality of transformation policies on the query, wherein the plurality of transformation policies transform time series data at ingestion; and
identifying at least one transformation policy of the plurality of transformation policies that reduces the execution cost of the query.

8. The method of claim 7, the method further comprising:
communicating the recommendation comprising the at least one transformation policy to an administrator of the time series data monitoring system, wherein the recommendation can be selectively enabled by the administrator.

9. The method of claim 7, the method further comprising:
automatically enabling the recommendation comprising the at least one transformation policy.

10. The method of claim 1, wherein the automatic transformation of at least a portion of times series data comprises transforming data points of time series data from an input observability format to an output observability format according to configuration rules of the time series data monitoring system.

11. The method of claim 1, wherein the automatic transformation of at least a portion of times series data comprises aggregating subsets of data points of time series data into aggregated data points.

12. A non-transitory computer readable storage medium having computer readable program code stored thereon for causing a computer system to perform a method for generating a recommendation for automatic transformation of times series data at ingestion, the method comprising:
analyzing historical query data of a time series data monitoring system, wherein the historical query data comprises a plurality of queries and data associated with execution of the plurality of queries;
determining, based on the analyzing, whether a response time of a query of the plurality of queries can be reduced by performing automatic transformation of at least a portion of times series data accessed responsive to the query at ingestion of the at least a portion of the times series data into the time series data monitoring system;
in response to determining that the response time of the query can be reduced by performing automatic transformation of the at least a portion of the times series data accessed responsive to the query at ingestion of the at least a portion of the times series data into the time series data monitoring system, generating a recommendation to perform the automatic transformation of the at least a portion of the times series data at ingestion into the time series data monitoring system; and
communicating the recommendation to perform the automatic transformation of the at least a portion of the times series data at ingestion into the time series data monitoring system to an administrator of the time series data monitoring system.

13. The non-transitory computer readable storage medium of claim 12, wherein the analyzing the historical query data of a time series data monitoring system comprises:
establishing at least one query response time threshold based at least in part on the historical query data, wherein a query response time greater than the at least one query response time threshold is indicated as a slow query.

14. The non-transitory computer readable storage medium of claim 13, wherein the establishing at least one query response time threshold based at least in part on the historical query data comprises:
using pattern matching to establish the at least one query response time threshold.

15. The non-transitory computer readable storage medium of claim 12, wherein the data associated with execution of the plurality of queries comprises query response times associated with each query of the plurality of queries.

16. The non-transitory computer readable storage medium of claim 12, wherein the generating a recommendation to perform the automatic transformation of the at least a portion of the times series data at ingestion into the time series data monitoring system comprises:
analyzing a plurality of transformation policies on the query, wherein the plurality of transformation policies transform time series data at ingestion; and
identifying at least one transformation policy of the plurality of transformation policies that reduces the response time of the query.

17. The non-transitory computer readable storage medium of claim 16, wherein the recommendation to perform the automatic transformation of the at least a portion of the times series data at ingestion into the time series data monitoring system comprises the at least one transformation policy.

18. The non-transitory computer readable storage medium of claim 12, wherein the automatic transformation of at least a portion of times series data comprises transforming data points of time series data from an input observability format to an output observability format according to configuration rules of the time series data monitoring system.

19. The non-transitory computer readable storage medium of claim 12, wherein the automatic transformation of at least a portion of times series data comprises aggregating subsets of data points of time series data into aggregated data points.

20. A time series data monitoring system for generating a recommendation for automatic transformation of time series data at ingestion, the time series data monitoring system comprising:
a persistent storage device;
a plurality of ingestion nodes, each node of the plurality of ingestion nodes comprising a data storage unit and a processor communicatively coupled with the data storage unit;
a plurality of query nodes, each query node of the plurality of query nodes comprising a data storage unit and a processor communicatively coupled with the data storage unit; and
a recommendation engine for generating a recommendation for automatic transformation of times series data at ingestion, wherein the recommendation engine is configured to:
analyze historical query data of a time series data monitoring system, wherein the historical query data comprises a plurality of queries and data associated with execution of the plurality of queries;
determine whether an execution cost of a query of the plurality of queries can be reduced by performing automatic transformation of at least a portion of times series data accessed responsive to the query at ingestion of the at least a portion of the times series data into the time series data monitoring system; and
generate a recommendation to perform the automatic transformation of the at least a portion of the times series data at ingestion into the time series data monitoring system in response to determining that the execution cost of the query can be reduced by performing automatic transformation of the at least a portion of the times series data accessed responsive to the query at ingestion of the at least a portion of the times series data into the time series data monitoring system.
